(19) United States
(12) Patent Application Publication
(10) Pub. No.: US 2015/0140857 A1
(43) Pub. Date: May 21, 2015

(54) Aluminum Electrical Wire with Crimped Terminal and Method for Producing Aluminum Electrical Wire with Crimped Terminal

(71) Applicant: YAZAKI CORPORATION, Tokyo (JP)

(72) Inventors: Kei Sato, Makinohara-shi (JP); Yuichi Ito, Makinohara-shi (JP)

(73) Assignee: YAZAKI CORPORATION, Tokyo (JP)

(21) Appl. No.: 14/610,289

(22) Filed: Jan. 30, 2015

Related U.S. Application Data
(63) Continuation of application No. PCT/JP2013/070515, filed on Jul. 29, 2013.

(30) Foreign Application Priority Data
Jul. 30, 2012 (JP) 2012-168152
Dec. 26, 2012 (JP) 2012-282043

(51) Int. Cl. H01R 13/52; H01R 4/18

(52) U.S. Cl. CPC H01R 13/5221; H01R 4/183
USPC 439/523

(57) ABSTRACT

Provided is an aluminum cable with crimping terminal in which a copper or copper alloy crimping terminal is crimped to a conductor that is exposed by peeling off an insulating covering member in a terminal portion of an aluminum cable in which an outer periphery of the conductor constituted by twisting a plurality of aluminum or aluminum alloy strands is covered with the insulating covering member. A water-repellent treatment with a water-repellent agent including a solvent having water-repellency is performed with respect to the conductor.

### CROSS REFERENCE TO RELATED APPLICATIONS

This application is a continuation of international patent application No. PCT/JP2013/070515 filed on Jul. 29, 2013 based on Japanese Patent Application No. 2012-168152 filed on Jul. 30, 2012, and Japanese Patent Application No. 2012-282043 filed on Dec. 26, 2012, the contents of which are incorporated herein by reference.

### BACKGROUND OF THE INVENTION

1. Field of the Invention

The present invention relates to an aluminum cable with crimping terminal, and a method for producing an aluminum cable with crimping terminal.

In addition, in this description, a cable produced from aluminum and a cable produced from an aluminum alloy are collectively referred to as an aluminum cable.

2. Description of the Related Art

In general, as a wire harness that is arranged in a vehicle such as an automobile, a copper cable, in which an outer periphery of a conductor obtained by twisting a plurality of copper strands is covered with an insulating covering member, is used. In addition, when connecting a plurality of the wire harnesses to each other, or when connecting the wire harness to an in-vehicle device, a terminal is attached to a copper cable of the wire harness. In general, this kind of terminal is attached to the copper cable by crimping.

Generally, a terminal that is crimped to the copper cable, that is, a so-called crimping terminal includes a bottom plate portion on which a conductor exposed by peeling off an insulating covering member of a terminal portion of the copper cable is mounted, and a pair of conductor crimping pieces which extends from the bottom plate portion and between which the conductor mounted on the bottom plate portion is interposed.

When the pair of conductor crimping pieces are caulked toward an inner side, the conductor of the copper cable is interposed between the pair of conductor crimping pieces and the bottom plate portion, and according to this, the crimping terminal is crimped to the conductor of the copper cable.

Recently, in consideration of reduction in weight of a vehicle and ease of recycling materials in addition to deficiency of copper resources, use of an aluminum cable instead of the copper cable has been studied. However, an oxide film formed on a surface of aluminum is thick in comparison to copper, and in the aluminum cable, a contact resistance between the conductor and the crimping terminal tends to relatively increase.

Accordingly, to reduce the contact resistance between the conductor of the aluminum cable and the crimping terminal, a method, in which a barrel (a conductor crimping portion) that is a crimping portion of the crimping terminal is strongly crimped to the conductor of the aluminum cable to increase a compression rate of the conductor of the aluminum cable, has been employed. According to this method, the conductor of the aluminum cable is strongly crimped, and thus the oxide film of each of the strands that constitute the conductor of the aluminum cable is broken, and thus a reduction in the contact resistance between the conductor of the aluminum cable and the crimping terminal is realized.

Incidentally, when water is interposed in a contact portion (crimping portion) between heterogeneous metals of an aluminum material and a copper material, it is known that both metals of aluminum and copper are dissolved in water as ions, and thus a potential difference and the like occur between aluminum and copper, and as a result, electrolytic corrosion occurs.

In a case of connecting the conductor of the aluminum cable and a copper or copper alloy crimping terminal to each other, a problem relating to the electrolytic corrosion due to connection between heterogeneous metals occurs.

In addition, with regard to a portion of the exposed conductor which is crimped by the barrel of the crimping terminal, since the barrel is crimped with high compression, water intrusion from a contact portion between the exposed conductor of the aluminum cable and the barrel of the crimping terminal is prevented, and thus it is possible to prevent the electrolytic corrosion from occurring.

However, at the front or back of the crimping terminal, which is crimped by the barrel of the crimping terminal, in an axial direction of the barrel, a core wire of the conductor of the aluminum cable comes into contact with crimping terminal in a state of being exposed. When water adheres to the exposed portion, a contact portion between the conductor of the aluminum cable and the barrel of the crimping terminal enters a state of being immersed in an electrolytic solution, and thus there is a concern that the electrolytic corrosion in which aluminum that is a metal having a large ionization tendency is dissolved may proceed.

Accordingly, in the related art, the conductor of the aluminum cable and the copper or copper alloy crimping terminal are brought into contact with each other, and then waterproof coating is applied in advance to the terminal of the exposed core wire in the aluminum cable so as to prevent water from being interposed in the contact portion between the conductor and the crimping terminal. Then, a wire barrel of a female terminal fitting is caulked and crimped to the terminal of the core wire in this state, and in the crimping portion of the wire barrel, the core wire and an inner surface of the wire barrel are brought into contact with each other while peeling off the waterproof coating so as to establish an electrical connection. There is disclosed a cable with a terminal fitting which has a configuration in which, even though the core wire comes into contact with a bottom plate of the female terminal fitting at the front or back of the crimping portion of the wire barrel in a state in which the core wire is exposed, since the waterproofing coating is applied to the core wire, water is prevented from adhering to a contact portion between the core wire and the bottom plate, thereby preventing the occurrence of the electrolytic corrosion (refer to JP-A-2010-55901).

### SUMMARY OF THE INVENTION

According to the crimping structure disclosed in JP-A-2010-55901, the waterproof coating is formed on the terminal (the entirety of the exposed portion) of the exposed core wire, and an example of a coating agent includes silicone rubber. The coating agent is applied by a spraying apparatus in an undiluted solution state, and is cured to form the waterproofing coating.

When being applied to the terminal (entirety of the exposed portion) of the exposed wire core, the coating agent becomes an insulating material. Accordingly, in the crimping structure disclosed in JP-A-2010-55901, even when crimping is performed with high compression at a crimping portion of the wire barrel with respect to the core wire, since a conductor of the exposed core wire of the aluminum cable is covered with the coating agent in addition to the oxide film formed on a surface, a contact resistance between the conductor of the aluminum cable and the crimping terminal increases, and thus a problem occurs in the electrical conduction state.

The present invention has been made in consideration of the above-described circumstances, and an object thereof is to provide an aluminum cable with crimping terminal, which is capable of maintaining a satisfactory electrical conduction state in a crimped portion between a conductor of an aluminum cable and a barrel of a copper or copper alloy crimping terminal, and which is capable of preventing electrolytic corrosion from occurring at a contact portion between the conductor of the aluminum cable and the barrel of the crimping terminal at the front or back of the barrel of the crimping terminal in an axial direction, and a method for producing the aluminum cable with crimping terminal.

The above object according to the present invention is achieved by the following configurations.

(1) An aluminum cable with crimping terminal, wherein a copper or copper alloy crimping terminal is crimped to a conductor that is exposed by peeling off an insulating covering member in a terminal portion of an aluminum cable in which an outer periphery of the conductor constituted by twisting a plurality of aluminum or aluminum alloy strands is covered with the insulating covering member, and wherein a water-repellent treatment with a water-repellent agent including a solvent having water-repellency is performed with respect to the exposed conductor.

(2) The aluminum cable with crimping terminal according to the configuration (1), the water-repellent treatment with the water-repellent agent is performed with respect to at least a portion of the exposed conductor which is exposed to outside air from the crimping terminal that is crimped.

(3) The aluminum cable with crimping terminal according to the configuration (2), wherein the crimping terminal includes a conductor crimping portion which includes a conductor-mounting bottom plate portion on which the exposed conductor is mounted and a pair of conductor crimping pieces which are erected in a cantilevered manner from both edges of the conductor-mounting bottom plate portion, and which is crimped to the conductor, and an insulating-cover crimping portion which includes an insulated-side mounting bottom plate portion which is connected to the conductor-mounting bottom plate portion and on which a portion of the aluminum cable covered with the insulating covering member is mounted and a pair of insulated-side crimping pieces which are erected in a cantilevered manner from both edges of the insulated-side mounting bottom plate portion, which is crimped to the insulating covering member, and which is connected to the conductor crimping portion along an extending direction of the aluminum cable, and the water-repellent treatment with the water-repellent agent is performed with respect to only a front end of the conductor which is exposed to outside air from the crimping terminal.

(4) The aluminum cable with crimping terminal according to the configuration (1) or (2), wherein the crimping terminal includes a conductor crimping portion which includes a conductor-mounting bottom plate portion on which the conductor is mounted and a pair of conductor crimping pieces that are erected in a cantilevered manner from both edges of the conductor-mounting bottom plate portion, and which is crimped to the conductor, an insulating-cover crimping portion which includes an insulated-side mounting bottom plate portion on which a portion of the aluminum cable covered with the insulating covering member is mounted and a pair of insulated-side crimping pieces that are erected in a cantilevered manner from both edges of the insulated-side mounting bottom plate portion, and which is crimped to the insulating covering member, and an intermediate bottom plate portion at which the conductor-mounting bottom plate portion and the insulated-side mounting bottom plate portion are interconnected to each other along an extending direction of the aluminum cable, and wherein the crimping terminal is crimped to the aluminum cable in such a manner that a front end on a peeling-off side of the insulating covering member is disposed inside the insulating-cover crimping portion or the conductor crimping portion.

(5) The aluminum cable with crimping terminal according to the configuration (1) or (2), wherein the crimping terminal includes a conductor crimping portion which includes a conductor-mounting bottom plate portion on which the conductor is mounted and a pair of conductor crimping pieces that are erected in a cantilevered manner from both edges of the conductor-mounting bottom plate portion, and which is caulked to the conductor, an insulating-cover crimping portion which includes an insulated-side mounting bottom plate portion on which a portion of the aluminum cable covered with the insulating covering member is mounted and a pair of insulated-side crimping pieces that are erected in a cantilevered manner from both edges of the insulated-side mounting bottom plate portion, and which is crimped to the insulating covering member, and an intermediate bottom plate portion at which the conductor-mounting bottom plate portion and the insulated-side mounting bottom plate portion are interconnected to each other along an extending direction of the aluminum cable, and wherein in a case where a front end on a peeling-off side of the insulating covering member of the aluminum cable is disposed on the intermediate bottom plate portion, a width of the intermediate bottom plate portion of the crimping terminal in an extending direction of the aluminum cable is set to be small.

(6) A method for producing an aluminum cable with crimping terminal in which a copper or copper alloy crimping terminal is crimped to a conductor that is exposed by peeling off an insulating covering member in a terminal portion of an aluminum cable in which an outer periphery of the conductor constituted by twisting a plurality of aluminum or aluminum alloy strands is covered with the insulating covering member, the method including an exposed conductor water-repellent treatment process of performing a water-repellent treatment to an outer peripheral surface of the exposed conductor with a water-repellent agent including a solvent having water-repellency.

(7) The method for producing the aluminum cable with crimping terminal according to the configuration (6), in the exposed conductor water-repellent treatment process, the water-repellent treatment with the water-repellent agent is performed with respect to the outer peripheral surface of the conductor before the crimping terminal is crimped.

(8) The method for producing the aluminum cable with crimping terminal according to the configuration (6) or (7), in the exposed conductor water-repellent treatment process, the water-repellent treatment with the water-repellent agent is performed with respect to at least a portion of the conductor which is exposed from the crimping terminal.

(9) The method for producing the aluminum cable with crimping terminal according to the configuration (6) or (7), wherein the exposed conductor water-repellent treatment process is performed by immersing the conductor in the water-repellent agent.

(10) The method for producing an aluminum cable with crimping terminal according to any one of the configurations (6) to (8), wherein in the exposed conductor water-repellent treatment process, the water-repellent agent is sprayed, is dropped, or is applied with respect to the conductor. According to the aluminum cable with crimping terminal according to the configuration (1), it is possible to maintain satisfactory electrical conduction connection at the crimping portion between the conductor of the aluminum cable and the conductor crimping portion of the copper or copper alloy crimping terminal, and thus it is possible to prevent electrolytic corrosion from occurring at a contact portion between the conductor of the aluminum cable and the conductor crimping portion of the crimping terminal at the front or back of the conductor crimping portion of the crimping terminal in an axial direction.

In addition, according to the aluminum cable with crimping terminal of the configuration (1), it is possible to prevent the electrolytic corrosion at a low cost.

According to the aluminum cable with crimping terminal according to the configuration (2), it is possible to have the same effect as the aluminum cable with crimping terminal according to the configuration (1). In addition, the water-repellent treatment with the water-repellent agent is performed with respect to at least a portion of the conductor which is exposed to outside air from the crimping terminal that is crimped, and thus it is possible to reduce the amount of the water-repellent agent used. As a result, it is possible to prevent the electrolytic corrosion at a low cost.

According to the aluminum cable with crimping terminal according to the configuration (3), it is possible to have the same effect as the aluminum cable with crimping terminal according to the configuration (1). In addition, the water-repellent agent is applied to only the front end of the conductor, and thus it is possible to reduce the amount of the water-repellent agent used. As a result, it is possible to prevent the electrolytic corrosion at a relatively low cost.

According to the aluminum cable with crimping terminal according to the configuration (4), it is possible to have the same effect as the aluminum cable with crimping terminal according to the configuration (1). In addition, the front end on a peeling off side of the insulating covering member is disposed inside the insulating-cover crimping portion or the conductor crimping portion, and thus intrusion of water from the front end on a peeling off side to the inside of the conductor is more effectively prevented.

According to the aluminum cable with crimping terminal according to the configuration (5), it is possible to have the same effect as the aluminum cable with crimping terminal according to the configuration (1). In addition, in a case where the front end on a peeling off side of the insulating covering member of the aluminum cable is disposed on the intermediate bottom plate portion, the width of the intermediate bottom plate portion of the crimping terminal in an extending direction of the aluminum cable is set to be small. Accordingly, a gap between the conductor crimping piece and the insulated-side crimping piece can be suppressed to be small, and thus it is possible to suppress a portion of the exposed conductor, which is exposed to outside air from the crimping terminal, to be small. Accordingly, intrusion of water into the conductor is more effectively prevented.

According to the method for producing the aluminum cable with crimping terminal according to the configuration (6), it is possible to maintain a satisfactory electrical conduction state at the crimping portion between the conductor of the aluminum cable and the conductor crimping portion of the copper or copper alloy crimping terminal, and thus it is possible to prevent electrolytic corrosion from occurring at a contact portion between the conductor of the aluminum cable and the conductor crimping portion of the crimping terminal at the front or back of the conductor crimping portion of the crimping terminal in an axial direction.

In addition, according to the method for producing the aluminum cable with crimping terminal according to the configuration (6), it is possible to prevent the electrolytic corrosion at a low cost.

According to the method for producing the aluminum cable with crimping terminal according to the configuration (7), it is possible to have the same effect as the method for producing the aluminum cable with crimping terminal according to the configuration (6). In addition, it is possible to easily perform the water-repellent treatment with the water-repellent agent with respect to the conductor.

According to the method for producing the aluminum cable with crimping terminal according to the configuration (8), it is possible to have the same effect as the method for producing the aluminum cable with crimping terminal according to the configuration (6). In addition, the water-repellent treatment with the water-repellent agent is performed with respect to only a portion exposed from the crimping terminal, and thus it is possible to reduce a the amount of the water-repellent agent used. As a result, it is possible to prevent the electrolytic corrosion at a relatively low cost.

According to the method for producing the aluminum cable with crimping terminal according to the configuration (9), it is possible to have the same effect as the method for producing the aluminum cable with crimping terminal according to the configuration (6). In addition, it is possible to more reliably apply the water-repellent agent with respect to the conductor, and thus it is possible to prevent electrolytic corrosion from occurring at a contact portion between the conductor of the aluminum cable and the conductor crimping portion of the crimping terminal at the front or back of the conductor crimping portion of the crimping terminal in an axial direction.

According to the method for producing the aluminum cable with crimping terminal according to the configuration (10), it is possible to have the same effect as the method for producing the aluminum cable with crimping terminal according to the configuration (6). In addition, it is possible to selectively perform the water-repellent treatment with the water-repellent agent with respect to the conductor, and thus it is possible to reduce the amount of the water-repellent agent used. As a result, it is possible to prevent the electrolytic corrosion at a relatively low cost. In addition, it is possible to prevent the electrolytic corrosion from occurring at a contact portion between the conductor of the aluminum cable and the conductor crimping portion of the crimping terminal with an easy process.

### BRIEF DESCRIPTION OF THE DRAWINGS

In the accompanying drawings:

FIG. 1 is an exploded perspective view illustrating Example 1 of an aluminum cable with crimping terminal according to an embodiment of the present invention;

FIG. 2 illustrates a first process of a process of producing the aluminum cable with crimping terminal according to Example 1 of the present invention, and is a perspective view of the aluminum cable;

FIG. 3 illustrates a second process of the process of producing the aluminum cable with crimping terminal according to Example 1 of the present invention, and illustrates a state in which a conductor of the aluminum cable is mounted on a conductor crimping portion of the crimping terminal;

FIG. 4 illustrates a third process of the process of producing the aluminum cable with crimping terminal according to Example 1 of the present invention, and illustrates a state in which the conductor crimping portion of the crimping terminal is crimped to the conductor of the aluminum cable;

FIG. 5 illustrates a fourth process of the process of producing the aluminum cable with crimping terminal according to Example 1 of the present invention, and illustrates a state in which attachment of the conductor of the aluminum cable to the crimping terminal is completed;

FIGS. 6A, 6B and 6C illustrate a modification example of the method for producing the aluminum cable with crimping terminal according to Example 1 of the present invention;

FIG. 7A is an exploded perspective view of an aluminum cable with crimping terminal according to Example 2 of the present invention;

FIG. 7B is a perspective view illustrating a state in which the crimping terminal is crimped to the aluminum cable;

FIG. 8 is a side view of an aluminum cable with crimping terminal according to Example 3 of the present invention, and illustrates a state in which a water-repellent agent is sprayed by a spraying sprayer;

FIG. 9 is a side view of an aluminum cable with crimping terminal according to Example 4 of the present invention, and illustrates a state in which a water-repellent agent is dropped by a dropping nozzle;

FIGS. 10A, 10B and 10C illustrate a sequence of producing an aluminum cable with crimping terminal according to Example 5 of the present invention;

FIG. 11 is a side view of an aluminum cable with crimping terminal according to Example 6 of the present invention;

FIG. 12 is a side view of an aluminum cable with crimping terminal according to Example 7 of the present invention; and

FIG. 13 is a side view of an aluminum cable with crimping terminal according to Example 8 of the present invention.

### DETAILED DESCRIPTION OF THE EXEMPLARY EMBODIMENTS

Hereinafter, specific examples of an aluminum cable with crimping terminal according to the present invention, and a method for producing the aluminum cable with crimping terminal will be described in detail with reference to the accompanying drawings.

### Example 1

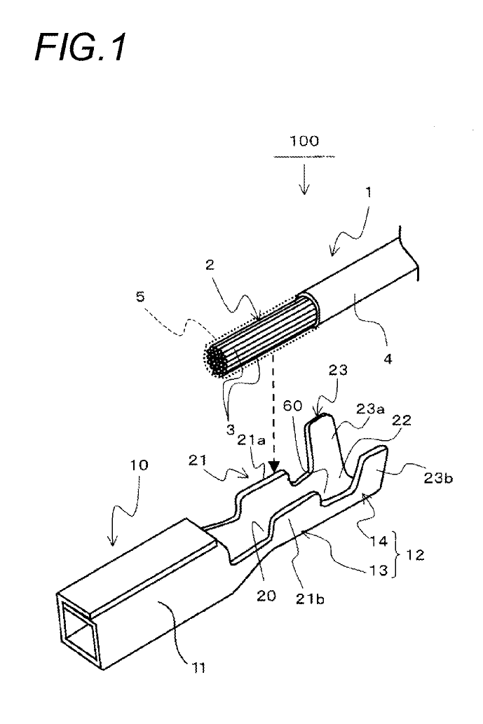

FIG. 1 is an exploded perspective view illustrating Example 1 of an aluminum cable with crimping terminal according to an embodiment of the present invention.

As shown in FIG. 1, an aluminum cable 1 includes a conductor 2 constituted by twisting a plurality of aluminum or aluminum alloy strands 3, and an outer periphery of the conductor 2 is covered with an insulating covering member 4.

Examples of the aluminum alloy that constitutes the aluminum cable 1 include an alloy of aluminum and iron. In comparison to an aluminum conductor, the alloy that is easily stretched can be further strengthened (particularly, tensile strength).

In addition, the insulating covering member 4 is peeled off from a terminal portion (front end of the cable) of the aluminum cable 1 with a predetermined length to expose the conductor 2, and a crimping terminal 10 is crimped to the terminal portion of the aluminum cable 1. A water-repellent agent 5 is applied to the conductor 2 over the entirety of an outer periphery of the conductor 2 (hereinafter, referred to as an “exposed conductor”) as indicated by a broken line in FIG. 1.

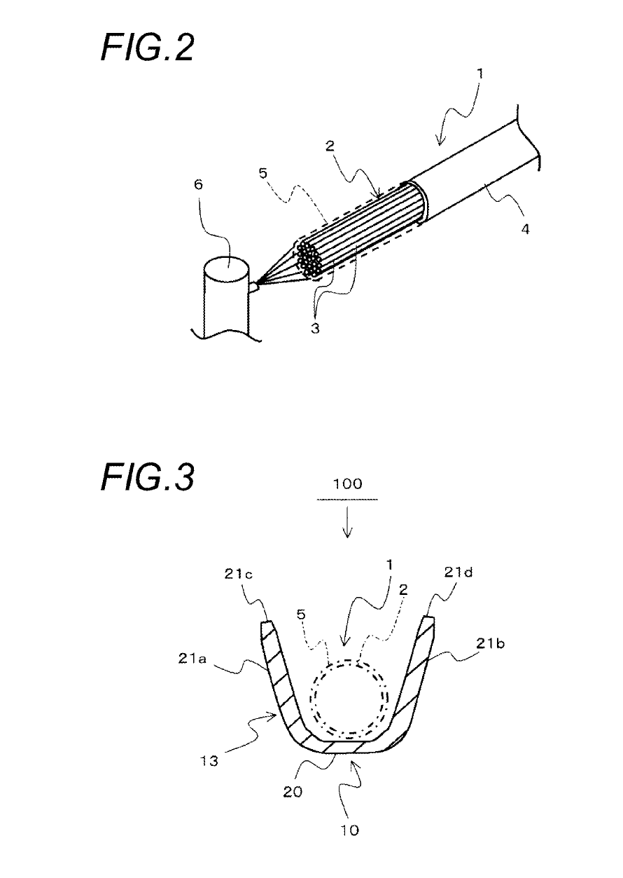

Examples of a method for applying the water-repellent agent 5 over the entirety of the outer periphery of the exposed conductor 2 as indicated by the broken line in FIG. 1 includes a method for spraying the water-repellent agent 5 over the entirety of the outer periphery of the exposed conductor 2 by a spraying sprayer 6 as shown in FIG. 2.

As the water-repellent agent 5, for example, a water-repellent agent, which contains a fluorine-containing resin as an effective component and a fluorine-containing organic solvent as a solvent, is used.

The water-repellent agent 5 includes a solvent having water-repellency. Among commercially available water-repellent agents, a kind of the water-repellent agent 5 is out of the question as long as the water-repellent agent 5 has excellent adhesiveness with the conductor 2 exposed by peeling off the insulating covering member 4 of the aluminum cable 1, and has durability. In addition, the film thickness of the water-repellent agent 5 that is applied to the exposed conductor 2 of the aluminum cable 1 may be set to a certain degree of thickness at which a water-repellent effect can be maintained in the exposed conductor 2 of the aluminum cable 1 for a long period of time.

As shown in FIG. 1, the crimping terminal 10 is formed by press-molding (including bending-molding) a sheet formed from a conductive metal such as a copper alloy. A portion 11 for terminal connection with a counterpart terminal (not shown) is provided at a front end of the crimping terminal 10, and a cable crimping portion 12 that is crimped to the aluminum cable 1 is provided to a base end thereof.

A conductor crimping portion 13 that is crimped to the exposed conductor 2 of the aluminum cable 1 is provided on a front end side of the cable crimping portion 12, and an insulating-cover crimping portion 14 that is crimped to a portion of the aluminum cable 1 covered with the insulating covering member 4 is provided on a base end side of the cable crimping portion 12.

The conductor crimping portion 13 includes a conductor-mounting bottom plate portion 20 on which the exposed conductor 2 is mounted, and a pair of conductor crimping pieces 21 that are erected in a cantilevered manner from both edges of the conductor-mounting bottom plate portion 20. The conductor crimping portion 13 is formed to have an approximately U-shape in a cross-section perpendicular to a longitudinal direction of the crimping terminal 10.

The conductor-mounting bottom plate portion 20 is configured to mount the conductor 2 exposed at a terminal portion of the aluminum cable 1.

In addition, the pair of conductor crimping pieces 21 are configured to extend to the conductor-mounting bottom plate portion 20 and to interpose the exposed conductor 2, which is mounted on the conductor-mounting bottom plate portion 20, therebetween.

The insulating-cover crimping portion 14 includes an insulated-side mounting bottom plate portion 22 on which a portion of the aluminum cable 1 covered with the insulating covering member 4 is mounted, and a pair of insulated-side crimping pieces 23 that are erected in a cantilevered manner from both edges of the insulated-side mounting bottom plate portion 22. The insulating-cover crimping portion 14 is molded to have an approximately U-shaped cross-section similar to the conductor crimping portion 13.

The insulated-side mounting bottom plate portion 22 of the insulating-cover crimping portion 14 extends to the base end of the conductor-mounting bottom plate portion 20 of the conductor crimping portion 13. More specifically, the cable crimping portion 12 includes an intermediate bottom plate portion 60 at which the conductor-mounting bottom plate portion 20 and the insulated-side mounting bottom plate portion 22 are interconnected to each other along an extending direction of the aluminum cable 1.

The exposed conductor 2 is mounted on the conductor-mounting bottom plate portion 20 of the crimping terminal 10 configured as described above, and a portion of the aluminum cable 1 covered with the insulating covering member 4 is mounted on the insulated-side mounting bottom plate portion 22 of the crimping terminal 10. Next, the pair of conductor crimping pieces 21 and the pair of insulated-side crimping pieces 23 are crimped, and thus the exposed conductor 2 of the aluminum cable 1 is wrapped by the pair of conductor crimping pieces 21 and comes into close contact with the conductor crimping portion 13. The portion of the aluminum cable 1 covered with the insulating covering member 4 is wrapped by the pair of insulated-side crimping pieces 23 and comes into close contact with the insulating-cover crimping portion 14.

In this way, in the portion crimped by the conductor crimping portion 13 of the crimping terminal 10, strong contact is realized by a crimping force of the pair of conductor crimping pieces 21, and thus intrusion of water does not occur.

On the other hand, in the exposed conductor 2 of the aluminum cable 1, the front end not covered with the pair of conductor crimping pieces 21, and a portion between the conductor crimping portion 13 and the insulating-cover crimping portion 14 (that is, a portion mounted on the intermediate bottom plate portion 60) are exposed to the outside. However, the water-repellent agent 5 is sprayed onto outer peripheral surfaces of these portions, and thus a water-repellent effect is provided. As a result, water is prevented from intruding into the inside of the conductor 2.

FIGS. 2 to 5 illustrate a first process to a fourth process in a process of producing the aluminum cable 100 with crimping terminal of Example 1 illustrated in FIG. 1.

As shown in FIG. 2, in the first process of the process of producing the aluminum cable 100 with crimping terminal, first, a predetermined length of the insulating covering member 4 is peeled off from the terminal portion (front end of the cable) of the aluminum cable 1 to expose the conductor 2 constituted by twisting the plurality of aluminum or aluminum alloy strands 3.

Next, the water-repellent agent 5 is sprayed onto the entirety of the outer periphery of the exposed conductor 2 by using the spraying sprayer 6. Due to the spraying of the water-repellent agent 5 by the spraying sprayer 6, the water-repellent agent 5 is applied over the entirety of the outer periphery of the exposed conductor 2.

The film thickness of the water-repellent agent 5 that is applied to the exposed conductor 2 by the spraying sprayer 6 is set to a certain degree of thickness at which a water-repellent effect can be maintained in the exposed conductor 2 for a long period of time.

In addition, a distance of the water-repellent agent 5, which is applied to the exposed conductor 2 by the spraying sprayer 6, from the front end of the exposed conductor 2 is set to a length capable of being exposed to the outside from the cable crimping portion 12 after the crimping terminal 10 is crimped.

In FIG. 2, the insulating covering member 4 of the aluminum cable 1 is peeled off to expose the conductor 2 constituted by twisting the plurality of aluminum or aluminum alloy strands 3, and when applying the water-repellent agent 5 to the entirety of the outer periphery of the exposed conductor 2, a method for spraying the water-repellent agent 5 by the spraying sprayer 6 is employed.

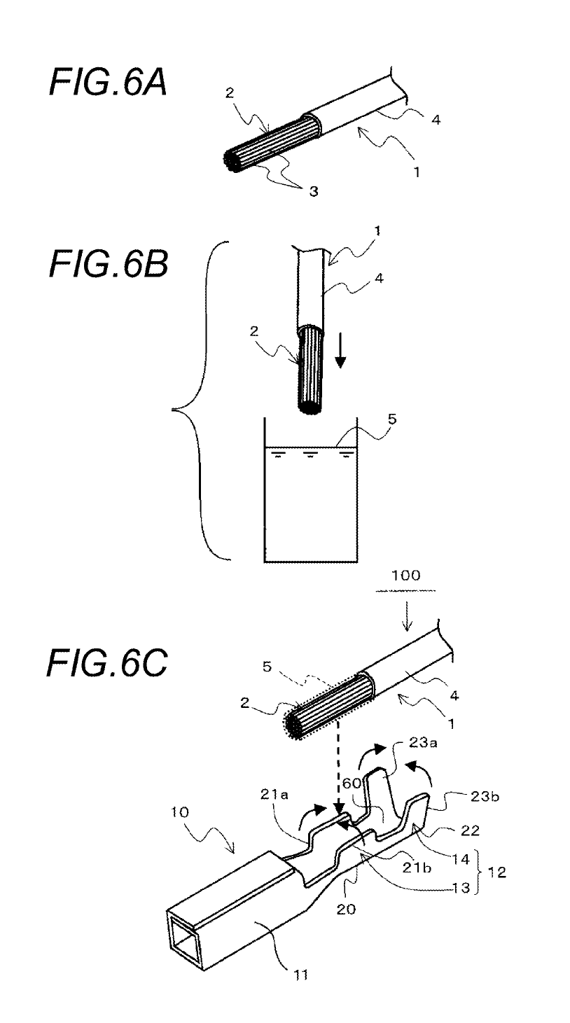

With regard to the application of the water-repellent agent 5 to the entirety of the outer periphery of the exposed conductor 2, there is no limitation to the method for spraying the water-repellent agent 5 by the spraying sprayer 6, and the following method is also possible. Specifically, as shown in FIGS. 6A to 6C, the insulating covering member 4 of the aluminum cable 1 is peeled off (refer to FIG. 6A) to expose the conductor 2 constituted by twisting the plurality of aluminum or aluminum alloy strands 3, the entirety of the exposed conductor 2 is immersed in a vessel containing the water-repellent agent 5 to apply the water-repellent agent 5 to the exposed conductor 2 (refer to FIG. 6B), and finally, the crimping terminal 10 is crimped to the aluminum cable 1 (refer to FIG. 6C). In this case, it is possible to more reliably apply the water-repellent agent 5 to the exposed conductor 2.

As described above, when the water-repellent agent 5 is applied to the entirety of the outer periphery of the exposed conductor 2, the process proceeds to the second process of the process of producing the aluminum cable 100 with crimping terminal which is illustrated in FIG. 3.

In the second process of the process of producing the aluminum cable 100 with crimping terminal as shown in FIG. 3, the exposed conductor 2 is mounted on the conductor crimping portion 13 of the crimping terminal 10 to be interposed between the conductor-mounting bottom plate portion 20 and the pair of conductor crimping pieces 21a and 21b that constitutes the conductor crimping piece 21.

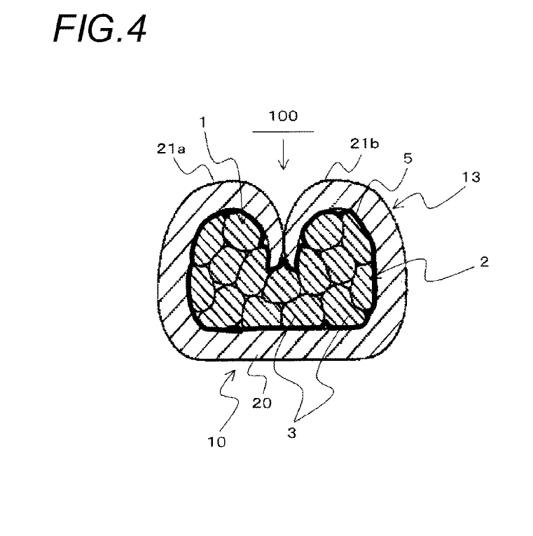

As described above, when the exposed conductor 2 is mounted on the conductor crimping portion 13 of the crimping terminal 10 to be interposed between the conductor-mounting bottom plate portion 20 and the pair of conductor crimping pieces 21a and 21b that constitutes the conductor crimping piece 21, the process proceeds to the third process of the process of producing the aluminum cable 100 with crimping terminal which is illustrated in FIG. 4.

In the third process of the process of producing the aluminum cable 100 with crimping terminal as shown in FIG. 4, the conductor crimping portion 13 of the crimping terminal 10 is crimped to the exposed conductor 2.

The conductor crimping portion 13 includes the conductor-mounting bottom plate portion 20 and the pair of conductor crimping pieces 21a and 21b that are formed to raise upward so as to extend toward an upper side from left and right edges of the conductor-mounting bottom plate portion 20. The pair of conductor crimping pieces 21a and 21b are inwardly bent to wrap the exposed conductor 2 to be connected, and are crimped to realize a state in which the exposed conductor 2 comes into close contact with an upper surface of the conductor-mounting bottom plate portion 20.

When the pair of conductor crimping pieces 21a and 21b are inwardly bent to wrap the exposed conductor 2, respectively, front ends 21c and 21d of the pair of conductor crimping pieces 21a and 21b are close to each other toward the conductor-mounting bottom plate portion 20 while rubbing outer surfaces thereof, and are bent toward a lower side of an arrangement direction (right-left direction) of the conductor crimping pieces 21a and 21b to penetrate into the exposed conductor 2.

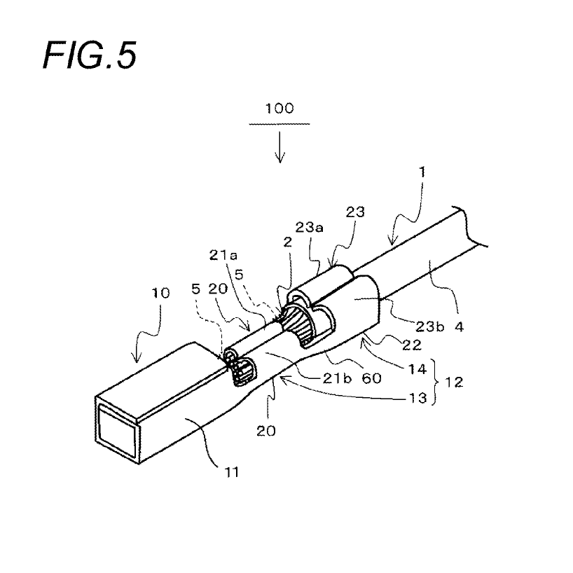

As described above, when the exposed conductor 2 is wrapped, and the exposed conductor 2 is crimped by the pair of conductor crimping pieces 21a and 21b so as to come into close contact with the upper surface of the conductor-mounting bottom plate portion 20, the process proceeds to the fourth process of the process of producing the aluminum cable 100 with crimping terminal which is illustrated in FIG. 5.

In the third process of the process of producing the aluminum cable 100 with crimping terminal as shown in FIG. 4, when the conductor crimping portion 13 of the crimping terminal 10 is crimped to the exposed conductor 2, production of the aluminum cable 100 with crimping terminal is completed as shown in FIG. 5.

As described above, the front end of the crimping terminal 10 is provided with the terminal connection portion 11 with a counterpart terminal (not shown), and the base end of the crimping terminal 10 is provided with the cable crimping portion 12 that is crimped to the aluminum cable 1. In addition, the conductor crimping portion 13, which is crimped to the exposed conductor 2 of the aluminum cable 1, is provided on a front end side of the cable crimping portion 12 of the crimping terminal 10, and the insulating-cover crimping portion 14 that crimps a portion of the aluminum cable 1 covered with the insulating covering member 4 is provided to a base end side of the cable crimping portion 12.

The exposed conductor 2 exposed at the terminal portion of the aluminum cable 1 is interposed between the pair of conductor crimping pieces 21a and 21b of the conductor crimping portion 13, and the portion of the aluminum cable 1 covered with the insulating covering member 4 is interposed between the pair of insulated-side crimping pieces 23a and 23b of the insulating-cover crimping portion 14.

In addition, with regard to the aluminum cable 1, when the pair of insulated-side crimping pieces 23a and 23b of the crimping terminal 10 are crimped, the portion of the aluminum cable 1 covered with the insulating covering member 4, and the insulating-cover crimping portion 14 of the crimping terminal 10 are reliably fixed to each other. When the pair of conductor crimping pieces 21a and 21b of the crimping terminal 10 are crimped, the exposed conductor 2 of the aluminum cable 1 and the conductor crimping portion 13 of the crimping terminal 10 are reliably fixed to each other.

With regard to the aluminum cable 1 configured as described above, in a portion crimped by the pair of conductor crimping pieces 21, strong contact is realized by a crimping force of the pair of conductor crimping pieces 21, and thus it is possible to prevent intrusion of water.

In addition, in a portion between the conductor crimping portion 13 and the insulating-cover crimping portion 14 of the crimping terminal 10 (that is, a portion which is mounted on the intermediate bottom plate portion 60 and is not covered with the pair of conductor crimping pieces 21 and the pair of insulated-side crimping pieces 23), the water-repellent agent 5 is applied to the outer peripheral surface of the conductor 2, and thus water is prevented from intruding into the inside of the conductor 2 due to a water-repellent effect of the water-repellent agent 5.

In the aluminum cable 100 with crimping terminal and the method for producing the aluminum cable 100 with crimping terminal according to Example 1 of the present invention, a satisfactory electrical conduction state is maintained at a crimped portion between the conductor 2 of the aluminum cable 1 and the conductor crimping portion 13 of the copper or copper alloy crimping terminal 10. Therefore, electrolytic corrosion is prevented from occurring at a contact portion between the conductor 2 of the aluminum cable 1 and the conductor crimping portion 13 of the crimping terminal 10 at the front or back of the conductor crimping portion 13 of the crimping terminal 10 in an axial direction thereof. In addition, it is possible to prevent the electrolytic corrosion at a low cost.

In addition, in the method for producing the aluminum cable 100 with crimping terminal according to Example 1 of the present invention, it is possible to prevent the electrolytic corrosion from occurring at the contact portion between the conductor 2 of the aluminum cable 1 and the conductor crimping portion 13 of the crimping terminal 10 by an easy process of spraying the water-repellent agent 5.

### Example 2

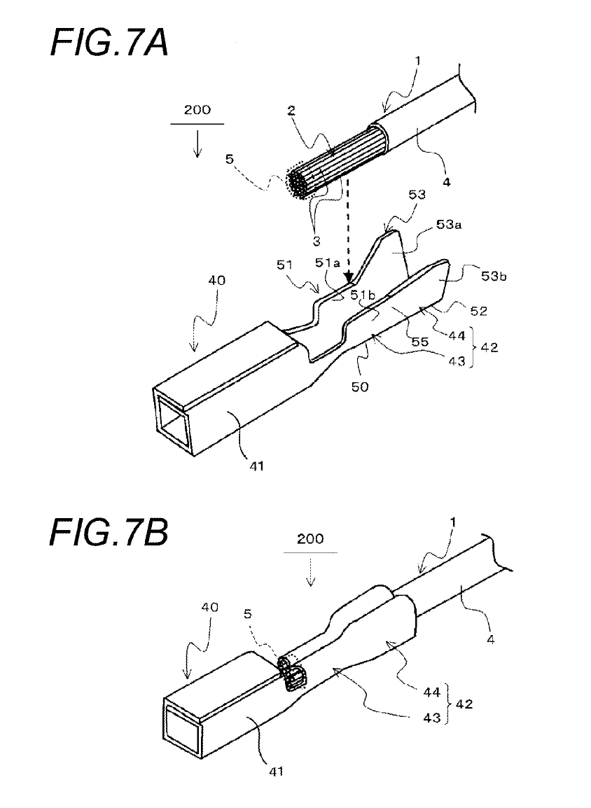

FIGS. 7A and 7B are exploded perspective views of an aluminum cable 200 with crimping terminal according to Example 2. FIG. 7A illustrates a state before a crimping terminal 40 is crimped to the aluminum cable 1, and FIG. 7B illustrates a state in which crimping of the crimping terminal 40 to the aluminum cable 1 is completed.

Example 2 illustrated in FIGS. 7A and 7B is different from Example 1 illustrated in FIG. 1 in a configuration of the crimping terminal 40, a configuration in which the water-repellent agent 5 applied to the conductor 2 of the aluminum cable 1 is applied to only the front end of the conductor 2 instead of the entirety of the outer periphery of the conductor 2, and a configuration in which a conductor crimping portion 43 and an insulating-cover crimping portion 44 of a cable crimping portion 42 are connected to each other.

The other configurations are the same as Example 1, and the same reference numerals are given to the same constituent portions as Example 1.

As shown in FIGS. 7A and 7B, the aluminum cable 1 has the same configuration as the aluminum cable 1 illustrated in FIG. 1. With regard to the aluminum cable 1, in a terminal portion (a front end of the cable), as indicated by a broken line, the water-repellent agent 5 is applied to only the front end of the conductor 2 exposed by removing the insulating covering member 4 in a predetermined length.

With regard to the water-repellent agent 5, among commercially available water-repellent agents, a kind of the water-repellent agent 5 is out of the question as long as the water-repellent agent 5 has excellent adhesiveness with the conductor 2 exposed by removing the insulating covering member 4 of the aluminum cable 1, and has durability. The film thickness of the water-repellent agent 5 that is applied to the exposed conductor 2 of the aluminum cable 1 may be set to a certain degree of thickness at which a water-repellent effect can be maintained in the exposed conductor 2 of the aluminum cable 1 for a long period of time.

In addition, a processing length of the water-repellent agent 5 that is applied to the front end of the conductor 2 of the aluminum cable 1 may be set to a length at which the water-repellent agent 5 is present up to a slightly inner side covered with the cable crimping portion 42 in comparison to a length of the water-repellent agent 5 exposed to the outside from the cable crimping portion 42 after the crimping terminal 40 is crimped.

As shown in FIGS. 7A and 7B, the crimping terminal 40 is formed by press-molding (including bending-molding) a sheet formed from a conductive metal such as a copper alloy. A portion 41 for terminal connection with a counterpart terminal (not shown) is provided at a front end of the crimping terminal 40, and the cable crimping portion 42 that is crimped to the aluminum cable 1 is provided to a base end thereof.

A conductor crimping portion 43 to which the exposed conductor 2 is crimped is provided on a front end side of the cable crimping portion 42, and an insulating-cover crimping portion 44 to which a portion of the aluminum cable 1 covered with the insulating covering member 4 is crimped is provided on a base end side of the cable crimping portion 42.

A portion ranging from a conductor-mounting bottom plate portion 50 of the conductor crimping portion 43 to an insulated-side mounting bottom plate portion 52 of the insulating-cover crimping portion 44 is continuously formed as a common bottom plate portion. In addition, as walls continuous to the conductor crimping piece 51 and the insulated-side crimping piece 53, a pair of covering walls 55, which are subjected to plastic deformation to cover a portion between the conductor crimping portion 43 and the insulating-cover crimping portion 44 in accordance with a process of crimping the conductor crimping piece 51 and the insulated-side crimping piece 53, are formed between a conductor crimping piece 51 of the conductor crimping portion 43 and an insulated-side crimping piece 53 of the insulating-cover crimping portion 44.

That is, the crimping terminal 40 includes the conductor crimping portion 43 and the insulating-cover crimping portion 44. The conductor crimping portion 43 includes the conductor-mounting bottom plate portion 50 on which the exposed conductor 2 is mounted, and the pair of conductor crimping pieces 51 that are erected in a cantilevered manner from both edges of the conductor-mounting bottom plate portion 50. In addition, the conductor crimping portion 43 is crimped to the exposed conductor 2. The insulating-cover crimping portion 44 includes the insulated-side mounting bottom plate portion 52 on which a portion of the aluminum cable 1 covered with the insulating covering member 4 is mounted, and the pair of insulated-side crimping pieces 53 that are erected in a cantilevered manner from both edges of the insulated-side mounting bottom plate portion 52. In addition, the insulating-cover crimping portion 44 is crimped to the insulating covering member 4, and is connected to the conductor crimping portion in an extending direction of the aluminum cable 1.

More specifically, the conductor crimping portion 43 includes the conductor-mounting bottom plate portion 50 and the pair of conductor crimping pieces 51 including a conductor crimping piece 51a and a conductor crimping piece 51b, and is formed to have an approximately U-shape in a cross-section perpendicular to a longitudinal direction of the crimping terminal 40.

The insulating-cover crimping portion 44 includes the insulated-side mounting bottom plate portion 52 and the pair of insulated-side crimping pieces 53 including an insulated-side crimping piece 53a and an insulated-side crimping piece 53b, and is formed to have an approximately U-shape in a cross-section perpendicular to the longitudinal direction of the crimping terminal 40.

The exposed conductor 2 of the aluminum cable 1 is mounted on the conductor-mounting bottom plate portion 50 of the crimping terminal 40 configured as described above, and a portion of the insulating covering member 4 of the aluminum cable 1 is mounted on the insulated-side mounting bottom plate portion 52 of the crimping terminal 40. Next, the pair of conductor crimping pieces 51a and 51b, the pair of covering walls 55, and the pair of insulated-side crimping pieces 53a and 53b are crimped, and thus the exposed conductor 2 of the aluminum cable 1 is wrapped by the pair of conductor crimping pieces 51 and comes into close contact with the conductor crimping portion 43. A portion ranging from the exposed conductor 2 to the portion of the aluminum cable 1 covered with the insulating covering member 4 is wrapped by the pair of covering walls 55 and comes into close contact with the covering walls 55. The portion of the aluminum cable 1 covered with the insulating covering member 4 is wrapped by the pair of insulated-side crimping piece 53 and comes into close contact with the insulating-cover crimping portion 44.

As described above, in the portion crimped by the pair of conductor crimping pieces 51 of the crimping terminal 40, the portion crimped by the pair of covering walls 55, and the portion crimped by the pair of insulated-side crimping pieces 53, strong contact is realized by a crimping force of the pair of conductor crimping pieces 51, a crimping force by the pair of covering walls 55, and a crimping force of the pair of insulated-side crimping pieces 53, and thus intrusion of water does not occur.

On the other hand, in the conductor 2 of the aluminum cable 1, a front end not covered with the pair of conductor crimping pieces 51 and a portion protruding to a front end side from the pair of conductor crimping pieces 51 are exposed to the outside. However, the water-repellent agent 5 is applied to the front end of the exposed conductor 2 of the aluminum cable 1, and thus a water-repellent effect is provided. As a result, water is prevented from intruding into the inside of the conductor 2.

The aluminum cable 200 with crimping terminal and the method for producing the aluminum cable 200 with crimping terminal according to Example 2 of the present invention have the same effect as the aluminum cable 100 with crimping terminal and the method for producing the aluminum cable 100 with crimping terminal according to Example 1. In addition, the water-repellent agent 5 is applied to only the front end of the exposed conductor 2, and thus the amount of the water-repellent agent 5 used can be reduced. As a result, it is possible to prevent the electrolytic corrosion at a relatively low cost.

### Example 3

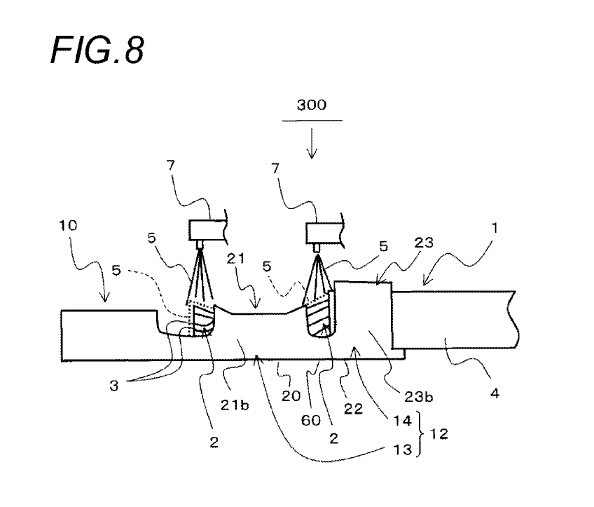

FIG. 8 is a side view of an aluminum cable 300 with crimping terminal according to Example 3 of the present invention, and illustrates a state in which the water-repellent agent 5 is sprayed by a spraying sprayer 7.

Example 3 illustrated in FIG. 8 is different from Example 1 illustrated in FIG. 1 in the following ways. In Example 1 illustrated in FIG. 1, the water-repellent agent 5 is applied to the entirety of the outer periphery of the conductor 2 of the terminal portion (front end of the cable) of the aluminum cable 1 from which the insulating covering member 4 is removed. In contrast, in Example 3 illustrated in FIG. 8, with respect to the front end of the conductor 2 of the aluminum cable 1, and a portion of the exposed conductor 2 which is not covered with the conductor crimping portion 13 of the crimping terminal 10 and is exposed to outside air, the water-repellent agent 5 is sprayed by the spraying sprayer 7 to perform water-repellent treatment with the water-repellent agent 5.

The other configurations are the same as Example 1, and the same reference numerals are given to the same constituent portions as Example 1.

In Example 3 illustrated in FIG. 8, the pair of conductor crimping pieces 21a and 21b of the conductor crimping portion 13 is inwardly bent to wrap the conductor 2 of the aluminum cable 1 which is to be connected, and is crimped to realize a state in which the conductor 2 of the aluminum cable 1 comes into close contact with an upper surface of the conductor-mounting bottom plate portion 20.

The exposed conductor 2 that is crimped by the pair of conductor crimping pieces 21a and 21b is not completely covered with the pair of conductor crimping pieces 21a and 21b even when being crimped, and a part of the exposed conductor 2 is exposed as shown in FIG. 8.

The water-repellent agent 5 is not applied to the exposed conductor 2. Therefore, water may intrude into a contact portion between the exposed conductor 2 and the conductor crimping portion 13 of the crimping terminal 10.

To prevent water from intruding into the contact portion between the exposed conductor 2 of the aluminum cable 1 and the conductor crimping portion 13 of the crimping terminal 10, with regard to the conductor 2 of the aluminum cable 1 which is crimped by the pair of conductor crimping pieces 21a and 21b, the water-repellent agent 5 is sprayed to the conductor 2, which is not covered with the pair of conductor crimping pieces 21a and 21b and is exposed, by the spraying sprayer 7 to perform the water-repellent treatment with the water-repellent agent 5.

As described above, once the water-repellent agent 5 is sprayed to the exposed conductor 2, which is crimped by the pair of conductor crimping pieces 21a and 21b, by the spraying sprayer 7 to perform the water-repellent treatment with the water-repellent agent, a water-repellent effect can be provided to the entirety of the conductor 2 of the aluminum cable 1.

In FIG. 8, two pieces of the spraying sprayers 7 are provided in a longitudinal direction of the conductor 2 of the aluminum cable 1. With regard to the exposed conductor 2 of the aluminum cable 1 which is crimped by the pair of conductor crimping pieces 21a and 21b, the water-repellent agent 5 is sprayed simultaneously to two sites of the conductor 2 which are not covered with the pair of conductor crimping pieces 21a and 21b and are exposed by using the spraying sprayer 7, thereby performing the water-repellent treatment with the water-repellent agent.

The water-repellent treatment with the water-repellent agent 5 may not be performed by providing two pieces of the spraying sprayers 7 and by simultaneously spraying the water-repellent agent 5 to the two sites of the conductor 2, which are not covered with the pair of conductor crimping pieces 21a and 21b and are exposed. The water-repellent treatment with the water-repellent agent may be performed by providing one spraying sprayer 7 and by continuously spraying the water-repellent agent 5 to the two sites of the conductor 2 which are not covered with the pair of conductor crimping pieces 21a and 21b and are exposed.

The aluminum cable 300 with crimping terminal and the method for producing the aluminum cable 300 with crimping terminal according to Example 3 of the present invention have the same effect as the aluminum cable 100 with crimping terminal and the method for producing the aluminum cable 100 with crimping terminal according to Example 1 of the present invention. In addition, the water-repellent treatment with the water-repellent agent 5 is performed with respect to at least a portion of the conductor 2 which is exposed to outside air from the crimping terminal 10 that is crimped, and thus a use amount of the water-repellent agent 5 can be reduced. As a result, it is possible to prevent the electrolytic corrosion at relatively low cost.

### Example 4

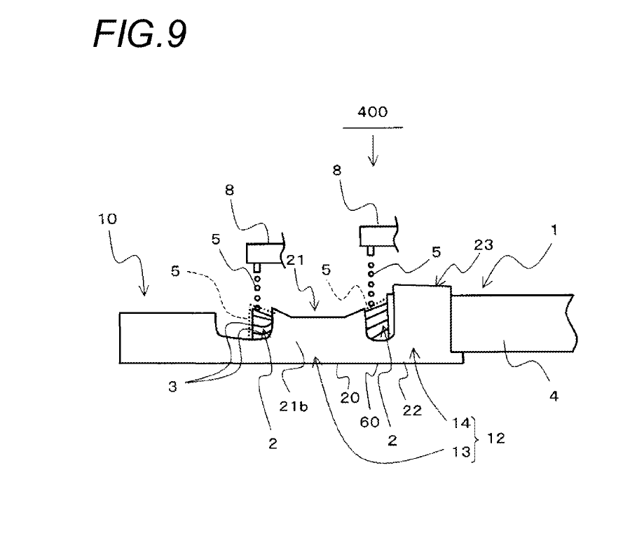

FIG. 9 is a side view of an aluminum cable 400 with crimping terminal according to Example 4 of the present invention, and illustrates a state in which the water-repellent agent is dropped by a dropping nozzle 8.

Example 4 illustrated in FIG. 9 is different from Example 1 illustrated in FIG. 1 in the following ways. In Example 1 illustrated in FIG. 1, the water-repellent agent 5 is applied to the entirety of the outer periphery of the conductor 2 of the terminal portion (front end of the cable) of the aluminum cable 1 from which the insulating covering member 4 is removed. In contrast, in Example 4 illustrated in FIG. 9, with respect to the front end of the conductor 2 of the aluminum cable 1, and the conductor 2 which is constituted by twisting a plurality of strands 3 and which is not covered with the conductor crimping portion 13 of the crimping terminal 10 and is exposed to outside air, the water-repellent agent 5 is dropped from the outside by the dropping nozzle 8 to perform the water-repellent treatment with the water-repellent agent 5.

The other configurations are the same as Example 1, and the same reference numerals are given to the same constituent portions as Example 1.

In Example 4 illustrated in FIG. 9, the pair of conductor crimping pieces 21a and 21b of the conductor crimping portion 13 are inwardly bent to wrap the conductor 2 of the aluminum cable 1 which is to be connected, and are crimped to realize a state in which the conductor 2 of the aluminum cable 1 comes into close contact with an upper surface of the conductor-mounting bottom plate portion 20.

The conductor 2 of the aluminum cable 1 which is crimped by the pair of conductor crimping pieces 21a and 21b is not completely covered with the pair of conductor crimping pieces 21a and 21b, and a part of the conductor 2 of the aluminum cable 1 is exposed as shown in FIG. 9.

The water-repellent agent 5 is not applied to the exposed conductor 2. Therefore, water may intrude into a contact portion between the exposed conductor 2 and the conductor crimping portion 13 of the crimping terminal 10.

To prevent water from intruding into the contact portion between the exposed conductor 2 of the aluminum cable 1 and the conductor crimping portion 13 of the crimping terminal 10, with regard to the conductor 2 of the aluminum cable 1 which is crimped by the pair of conductor crimping pieces 21a and 21b, the water-repellent agent 5 is dropped to the conductor 2, which is not covered with the pair of conductor crimping pieces 21a and 21b and is exposed, by the dropping nozzle 8 to perform the water-repellent treatment with the water-repellent agent 5.

As described above, once the water-repellent agent 5 is dropped to the conductor 2 of the aluminum cable 1, which is crimped by the pair of conductor crimping pieces 21a and 21b, by the dropping nozzle 8 to perform the water-repellent treatment with the water-repellent agent 5, a water-repellent effect can be provided to the entirety of the conductor 2 of the aluminum cable 1.

In FIG. 9, two pieces of the dropping nozzles 8 are provided in a longitudinal direction of the conductor 2 of the aluminum cable 1. With regard to the conductor 2 of the aluminum cable 1 which is crimped by the pair of conductor crimping pieces 21a and 21b, the water-repellent agent 5 is dropped simultaneously to two sites of the conductor 2 which are not covered with the pair of conductor crimping pieces 21a and 21b and are exposed by using the dropping nozzle 8, thereby performing the water-repellent treatment with the water-repellent agent 5.

The water-repellent treatment with the water-repellent agent 5 may not be performed by providing two pieces of the dropping nozzles 8 and by simultaneously dropping the water-repellent agent 5 to the two sites of the conductor 2, which are not covered with the pair of conductor crimping pieces 21a and 21b and are exposed. The water-repellent treatment with the water-repellent agent may be performed by providing one dropping nozzle 8 and by continuously dropping the water-repellent agent 5 to the two sites of the conductor 2 which are not covered with the pair of conductor crimping pieces 21a and 21b and are exposed.

The aluminum cable 400 with crimping terminal and the method for producing the aluminum cable 400 with crimping terminal according to Example 4 of the present invention have the same effect as the aluminum cable 100 with crimping terminal and the method for producing the aluminum cable 100 with crimping terminal according to Example 1 of the present invention. In addition, the water-repellent treatment with the water-repellent agent 5 is performed with respect to at least a portion of the conductor 2 which is exposed to outside air from the crimping terminal 10 that is crimped, and thus a use amount of the water-repellent agent 5 can be reduced. As a result, it is possible to prevent the electrolytic corrosion at relatively low cost.

In addition, in the method for producing the aluminum cable 400 with crimping terminal according to Example 4 of the present invention, it is possible to prevent electrolytic corrosion from occurring at a contact portion between the conductor 2 of the aluminum cable 1 and the conductor crimping portion 13 of the crimping terminal 10 with an easy process of dropping the water-repellent agent 5.

### Example 5

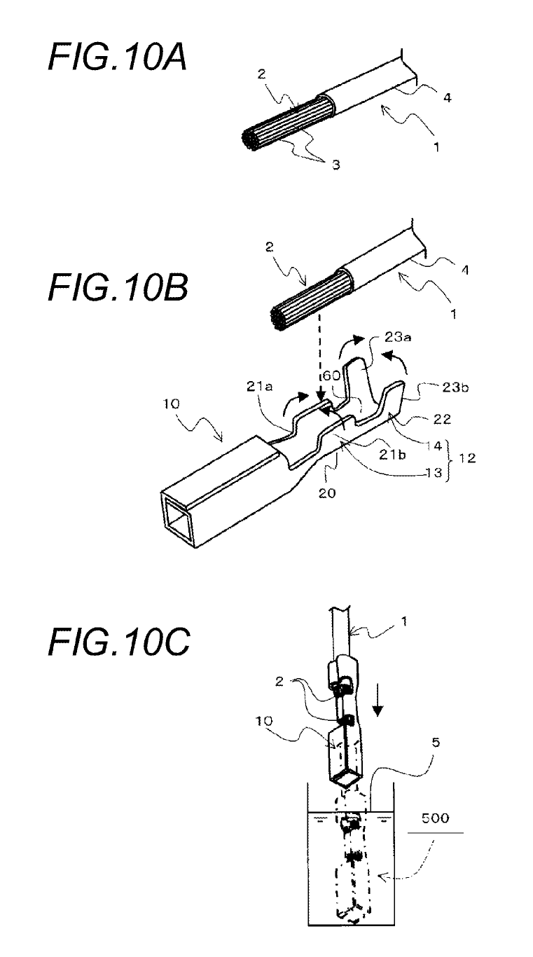

FIGS. 10A to 10C illustrate a sequence of producing an aluminum cable 500 with crimping terminal according to Example 5 of the present invention.

The aluminum cable 500 with crimping terminal which is illustrated in FIGS. 10A to 10C is different from the aluminum cable 100 with crimping terminal of Example 1 illustrated in FIG. 1 in that not only the exposed conductor 2 but also the crimping terminal 10 that is crimped is immersed in the water-repellent agent 5 to perform the water-repellent treatment with respect to the exposed conductor 2.

The other configurations are the same as Example 1, and the same reference numerals are given to the same constituent portions as Example 1.

In the aluminum cable 500 with crimping terminal, the insulating covering member 4 of the aluminum cable 1 is peeled off (refer to FIG. 10A) to expose the conductor 2 that is constituted by twisting a plurality of aluminum or aluminum alloy strands 3, the crimping terminal 10 is crimped to the aluminum cable 1 (refer to FIG. 10B), and finally, the crimping terminal 10 and the entirety of the exposed conductor 2 are immersed in a vessel in which the water-repellent agent 5 is contained to apply the water-repellent agent 5 thereto. According to this, production of the aluminum cable 500 with crimping terminal is completed (refer to FIG. 10C).

Since it is possible to reliably perform the water-repellent treatment with respect to the exposed conductor 2 exposed to outside air from the crimping terminal 10, and thus the aluminum cable 500 with crimping terminal and the method for producing the aluminum cable 500 with crimping terminal according to Example 5 of the present invention have the same effect as the aluminum cable 100 with crimping terminal and the method for producing the aluminum cable 100 with crimping terminal according to Example 1.

### Example 6

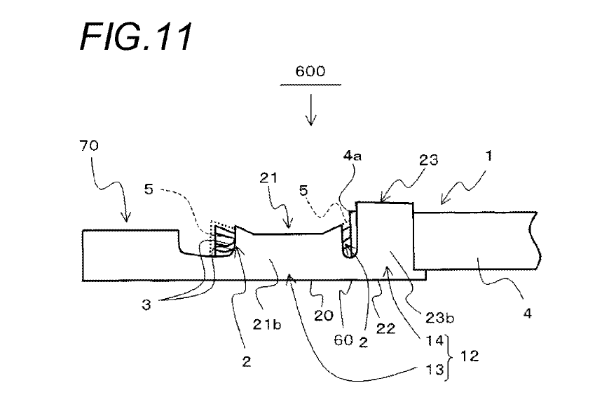

FIG. 11 is a side view of an aluminum cable 600 with crimping terminal according to Example 6 of the present invention.

The aluminum cable 600 with crimping terminal which is illustrated in FIG. 11 is different from the aluminum cable with crimping terminal 1 of Example 1 in that a crimping terminal 70, in which an intermediate bottom plate portion 60 is set to be relatively small, is used instead of the crimping terminal 10.

The other configurations are the same as Example 1, and the same reference numerals are given to the same constituent portions as Example 1.

In the crimping terminal 70, a width of the intermediate bottom plate portion 60 in an extending direction of the aluminum cable 1 is set to be small.

The exposed conductor 2 is subjected to the water-repellent treatment with the water-repellent agent 5 in the same manner as in Example 1, and thus the aluminum cable 600 with crimping terminal of Example 6 has the same effect as the aluminum cable 100 with crimping terminal of Example 1. In addition, a gap between the conductor crimping piece 21 and the insulated-side crimping piece 23 is suppressed to be small, and thus it is possible to suppress a portion of the exposed conductor 2, which is exposed to outside air from the crimping terminal 70, to be relatively small. Accordingly, intrusion of water into the conductor 2 is more effectively prevented.

### Example 7

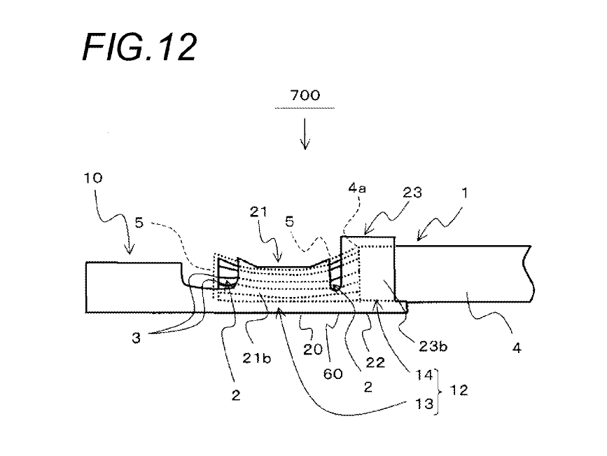

FIG. 12 is a side view of an aluminum cable 700 with crimping terminal according to Example 7 of the present invention.

The aluminum cable 700 with crimping terminal which is illustrated in FIG. 12 is different from the aluminum cable 100 with crimping terminal of Example 1 in that crimping of the crimping terminal 10 is performed in such a manner that a front end 4a on a peeling-off side of the insulating covering member 4 is disposed inside the insulating-cover crimping portion 14.

The other configurations are the same as Example 1, and the same reference numerals are given to the same constituent portions as Example 1.

The exposed conductor 2 is subjected to the water-repellent treatment with the water-repellent agent 5 in the same manner as in Example 1, and thus the aluminum cable 700 with crimping terminal of Example 7 has the same effect as the aluminum cable 100 with crimping terminal of Example 1. In addition, crimping of the crimping terminal 10 is performed in such a manner that the front end 4a on a peeling-off side of the insulating covering member 4 of the aluminum cable 1 is disposed inside the insulating-cover crimping portion 14. Accordingly, intrusion of water into the conductor 2 is more effectively prevented.

### Example 8

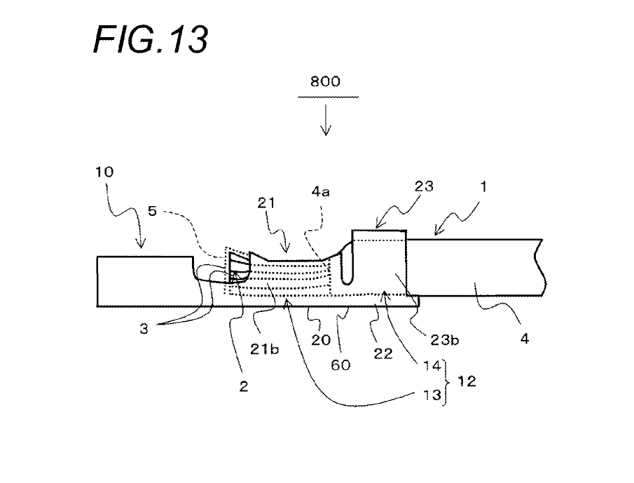

FIG. 13 is a side view of an aluminum cable 800 with crimping terminal of Example 8 relating to the aluminum cable with crimping terminal according to the present invention.

The aluminum cable 800 with crimping terminal which is illustrated in FIG. 13 is different from the aluminum cable 100 with crimping terminal of Example 1 in that crimping of the crimping terminal 10 is performed in such a manner that a front end 4a on a peeling-off side of the insulating covering member 4 is disposed inside the conductor crimping portion 13.

The other configurations are the same as Example 1, and the same reference numerals are given to the same constituent portions as Example 1.

The exposed conductor 2 is subjected to the water-repellent treatment with the water-repellent agent 5 in the same manner as in Example 1, and thus the aluminum cable 800 with crimping terminal of Example 8 has the same effect as the aluminum cable 100 with crimping terminal of Example 1. In addition, crimping of the crimping terminal 10 is performed in such a manner that the front end 4a on a peeling-off side of the insulating covering member 4 of the aluminum cable 1 is disposed inside the conductor crimping portion 13. Accordingly, intrusion of water into the conductor 2 is more effectively prevented.

In the aluminum cables 100, 200, 300, 400, 500, 600, 700, and 800 with crimping terminal, and the methods for producing the aluminum cables 100, 200, 300, 400, 500, 600, 700, and 800 with crimping terminal according to Examples 1 to 8 of the present invention, a configuration, in which the water-repellent treatment is performed with respect to the aluminum cable 1 by spraying or dropping the water-repellent agent 5, is exemplified, but there is no limitation to this configuration, and the water-repellent agent 5 may be applied to the aluminum cable 1 by applying the water-repellent agent 5. For example, the water-repellent agent 5 may be applied to the aluminum cable 1 by using a brush. In this case, according to the methods for producing the aluminum cables with crimping terminal, it is possible to prevent the electrolytic corrosion from occurring at a contact portion between the conductor 2 of the aluminum cable 1 and the conductor crimping portion 13 of the crimping terminal 10 by an easy process of applying the water-repellent agent 5.

Here, characteristics of embodiments of the aluminum cable with terminal according to the present invention will be described below in a brief and collective manner.

[1] An aluminum cable 100 with crimping terminal in which a copper or copper alloy crimping terminal 10 is crimped to a conductor 2 that is exposed by peeling off an insulating covering member 4 in a terminal portion of an aluminum cable 1 in which an outer periphery of the conductor 2 constituted by twisting a plurality of aluminum or aluminum alloy strands 3 is covered with the insulating covering member 4, wherein a water-repellent treatment with a water-repellent agent 5 including a solvent having water-repellency is performed with respect to the exposed conductor 2.

[2] The aluminum cable 300, 400 with crimping terminal according to the configuration (1), the water-repellent treatment with the water-repellent agent 5 is performed with respect to at least a portion of the exposed conductor 2 which is exposed to outside air from the crimping terminal 10 that is crimped.

[3] The aluminum cable 200 with crimping terminal according to the configuration (2), wherein the crimping terminal 40 includes a conductor crimping portion 43 which includes a conductor-mounting bottom plate portion 50 on which the exposed conductor 2 is mounted and a pair of conductor crimping pieces 51 which are erected in a cantilevered manner from both edges of the conductor-mounting bottom plate portion 50, and which is crimped to the conductor 2, and an insulating-cover crimping portion 44 which includes an insulated-side mounting bottom plate portion 52 which is connected to the conductor-mounting bottom plate portion 50 and on which a portion of the aluminum cable 1 covered with the insulating covering member 4 is mounted and a pair of insulated-side crimping pieces 53 which are erected in a cantilevered manner from both edges of the insulated-side mounting bottom plate portion 52, which is crimped to the insulating covering member 4, and which is connected to the conductor crimping portion 43 along an extending direction of the aluminum cable 1, and the water-repellent treatment with the water-repellent agent 5 is performed with respect to only a front end of the conductor 2 which is exposed to outside air from the crimping terminal 40.

[4] The aluminum cable 700, 800 with crimping terminal according to the configuration (1) or (2), wherein the crimping terminal 10 includes a conductor crimping portion 13 which includes a conductor-mounting bottom plate portion 20 on which the conductor 2 is mounted and a pair of conductor crimping pieces 21 that are erected in a cantilevered manner from both edges of the conductor-mounting bottom plate portion 20, and which is crimped to the conductor 2, an insulating-cover crimping portion 14 which includes an insulated-side mounting bottom plate portion 22 on which a portion of the aluminum cable 1 covered with the insulating covering member 4 is mounted and a pair of insulated-side crimping pieces 23 that are erected in a cantilevered manner from both edges of the insulated-side mounting bottom plate portion 22, and which is crimped to the insulating covering member 4, and an intermediate bottom plate portion 60 at which the conductor-mounting bottom plate portion 20 and the insulated-side mounting bottom plate portion 22 are interconnected to each other along an extending direction of the aluminum cable 1, and the crimping terminal 10 is crimped to the aluminum cable 1 in such a manner that a front end 4a on a peeling-off side of the insulating covering member 4 is disposed inside the insulating-cover crimping portion 14 or the conductor crimping portion 13.

[5] The aluminum cable 600 with crimping terminal according to the configuration (1) or (2), wherein the crimping terminal 70 includes a conductor crimping portion 13 which includes a conductor-mounting bottom plate portion 20 on which the conductor 2 is mounted and a pair of conductor crimping pieces 21 that are erected in a cantilevered manner from both edges of the conductor-mounting bottom plate portion 20, and which is caulked to the conductor 2, an insulating-cover crimping portion 14 which includes an insulated-side mounting bottom plate portion 22 on which a portion of the aluminum cable 1 covered with the insulating covering member 4 is mounted and a pair of insulated-side crimping pieces 23 that are erected in a cantilevered manner from both edges of the insulated-side mounting bottom plate portion 22, and which is crimped to the insulating covering member 4, and an intermediate bottom plate portion 60 at which the conductor-mounting bottom plate portion 20 and the insulated-side mounting bottom plate portion 22 are interconnected to each other along an extending direction of the aluminum cable 1, and in a case where a front end 4a on a peeling-off side of the insulating covering member 4 of the aluminum cable 1 is disposed on the intermediate bottom plate portion 60, a width of the intermediate bottom plate portion 60 of the crimping terminal 70 in an extending direction of the aluminum cable 1 is set to be small.

[6] A method for producing an aluminum cable 100 with crimping terminal in which a copper or copper alloy crimping terminal 10 is crimped to a conductor 2 that is exposed by peeling off an insulating covering member 4 in a terminal portion of an aluminum cable 1 in which an outer periphery of the conductor 2 constituted by twisting a plurality of aluminum or aluminum alloy strands 3 is covered with the insulating covering member 4, the method including an exposed conductor water-repellent treatment process of performing a water-repellent treatment to an outer peripheral surface of the exposed conductor 2 with a water-repellent agent 5 including a solvent having water-repellency.

[7] The method for producing the aluminum cable 100 with crimping terminal according to the configuration (6), in the exposed conductor water-repellent treatment process, the water-repellent treatment with the water-repellent agent 5 is performed with respect to the outer peripheral surface of the conductor 2 before the crimping terminal 10 is crimped.

[8] The method for producing the aluminum cable 200, 300, 400 with crimping terminal according to the configuration (6) or (7), in the exposed conductor water-repellent treatment process, the water-repellent treatment with the water-repellent agent 5 is performed with respect to at least a portion of the conductor 2 which is exposed from the crimping terminal 10, 40.

[9] The method for producing the aluminum cable 500 with crimping terminal according to the configuration (6) or (7), the exposed conductor water-repellent treatment process is performed by immersing the conductor 2 in the water-repellent agent 5.

[10] The method for producing an aluminum cable 100, 300, 400, 600, 700, 800 with crimping terminal according to any one of the configurations (6) to (8), in the exposed conductor water-repellent treatment process, the water-repellent agent 5 is sprayed, is dropped, or is applied with respect to the conductor 2.

The aluminum cable with terminal according to the present invention is not limited to the above-described embodiments, and a change, a modification, and the like can be made in an appropriate manner. In addition, materials, shapes, dimensions, numbers, disposition sites, and the like of respective constituent elements in the above-described embodiments are arbitrary, and are not limited thereto.

It is possible to provide an aluminum cable with crimping terminal, which is capable of maintaining a satisfactory electrical conduction state in a crimped portion between a conductor of an aluminum cable and a barrel of a copper or copper alloy crimping terminal, and which is capable of preventing electrolytic corrosion from occurring at a contact portion between the conductor of the aluminum cable and the barrel of the crimping terminal at the front or back of the barrel of the crimping terminal in an axial direction, and a method for producing the aluminum cable with crimping terminal.

What is claimed is:

1. An aluminum cable with crimping terminal, wherein
a copper or copper alloy crimping terminal is crimped to a conductor that is exposed by peeling off an insulating covering member in a terminal portion of an aluminum cable in which an outer periphery of the conductor constituted by twisting a plurality of aluminum or aluminum alloy strands is covered with the insulating covering member, and wherein
a water-repellent treatment with a water-repellent agent including a solvent having water-repellency is performed with respect to the exposed conductor.

2. The aluminum cable with crimping terminal according to claim 1, wherein
the water-repellent treatment with the water-repellent agent is performed with respect to at least a portion of the exposed conductor which is exposed to outside air from the crimping terminal that is crimped.

3. The aluminum cable with crimping terminal according to claim 2, wherein
the crimping terminal includes
a conductor crimping portion which includes a conductor-mounting bottom plate portion on which the exposed conductor is mounted and a pair of conductor crimping pieces which are erected in a cantilevered manner from both edges of the conductor-mounting bottom plate portion, and which is crimped to the conductor, and
an insulating-cover crimping portion which includes an insulated-side mounting bottom plate portion which is connected to the conductor-mounting bottom plate portion and on which a portion of the aluminum cable covered with the insulating covering member is mounted and a pair of insulated-side crimping pieces which are erected in a cantilevered manner from both edges of the insulated-side mounting bottom plate portion, which is crimped to the insulating covering member, and which is connected to the conductor crimping portion along an extending direction of the aluminum cable, and wherein
the water-repellent treatment with the water-repellent agent is performed with respect to only a front end of the conductor which is exposed to outside air from the crimping terminal.

4. The aluminum cable with crimping terminal according to claim 1, wherein
the crimping terminal includes
a conductor crimping portion which includes a conductor-mounting bottom plate portion on which the conductor is mounted and a pair of conductor crimping pieces that are erected in a cantilevered manner from both edges of the conductor-mounting bottom plate portion, and which is crimped to the conductor,
an insulating-cover crimping portion which includes an insulated-side mounting bottom plate portion on which a portion of the aluminum cable covered with the insulating covering member is mounted and a pair of insulated-side crimping pieces that are erected in a cantilevered manner from both edges of the insulated-side mounting bottom plate portion, and which is crimped to the insulating covering member, and
an intermediate bottom plate portion at which the conductor-mounting bottom plate portion and the insulated-side mounting bottom plate portion are interconnected to each other along an extending direction of the aluminum cable, and wherein
the crimping terminal is crimped to the aluminum cable in such a manner that a front end on a peeling-off side of the insulating covering member is disposed inside the insulating-cover crimping portion or the conductor crimping portion.

5. The aluminum cable with crimping terminal according to claim 1, wherein
the crimping terminal includes
a conductor crimping portion which includes a conductor-mounting bottom plate portion on which the conductor is mounted and a pair of conductor crimping pieces that are erected in a cantilevered manner from both edges of the conductor-mounting bottom plate portion, and which is caulked to the conductor,
an insulating-cover crimping portion which includes an insulated-side mounting bottom plate portion on which a portion of the aluminum cable covered with the insulating covering member is mounted and a pair of insulated-side crimping pieces that are erected in a cantilevered manner from both edges of the insulated-side mounting bottom plate portion, and which is crimped to the insulating covering member, and
an intermediate bottom plate portion at which the conductor-mounting bottom plate portion and the insulated-side mounting bottom plate portion are interconnected to each other along an extending direction of the aluminum cable, and wherein
in a case where a front end on a peeling-off side of the insulating covering member of the aluminum cable is disposed on the intermediate bottom plate portion, a width of the intermediate bottom plate portion of the crimping terminal in an extending direction of the aluminum cable is set to be small.
